(19) United States
(12) Patent Application Publication
(10) Pub. No.: US 2025/0196314 A1
(43) Pub. Date: Jun. 19, 2025

(54) ADJUSTABLE ANGLE TOOL

(71) Applicant: Hong Ann Tool Industries Co., Ltd., Taichung City (TW)

(72) Inventor: Cheng-Wei SU, Taichung City (TW)

(21) Appl. No.: 18/950,701

(22) Filed: Nov. 18, 2024

(30) Foreign Application Priority Data
Dec. 19, 2023 (TW) 112149581

(51) Int. Cl. B25G 3/38; A47L 13/022; A47L 13/08

(52) U.S. Cl. CPC B25G 3/38; A47L 13/022; A47L 13/08

(57) ABSTRACT

An adjustable angle tool comprises a handle, a tool head, and a positioning device. The handle extends along a first direction. The tool head is pivotally connected to the handle and is provided with a plurality of first positioning portions. The positioning device includes a positioning member and at least one biasing member. The positioning member is configured to be biased by the at least one biasing member along the first direction and detachably engaged with one of the plurality of first positioning portions to adjust a relative angle between the tool head and the handle.

### BACKGROUND OF THE INVENTION

The present invention relates to an adjustable angle tool.

The scraper includes a handle and a tool head connected to one end of the handle. The front end of the tool head is provided with a scraping edge, which is used for scraping operations. In existing scrapers, the tool head and the handle are of a fixed structure. In other words, the angle between the tool head and the handle is fixed and unchangeable. In some special scraping environments or narrow spaces, it is difficult to operate, and to achieve the scraping effect, the user can only change the angle between the tool head and the handle by hand, affecting the efficiency and effectiveness of the scraping operation.

### SUMMARY OF THE INVENTION

An objective of the present invention is to provide an adjustable angle tool that comprises a handle, a tool head, and a positioning device. The handle extends along a first direction. The tool head is pivotally connected to the handle and is provided with a plurality of first positioning portions. The positioning device includes a positioning member and at least one biasing member. The positioning member is configured to be biased by the at least one biasing member along the first direction and detachably engaged with one of the plurality of first positioning portions to adjust a relative angle between the tool head and the handle.

In an embodiment, the handle has a first pivoting end. The tool head has a second pivoting end pivotally connected to the first pivoting end, and an operating end opposite to the second pivoting end. The plurality of first positioning portions are arranged at equal angles on an arcuate outer edge wall of the second pivoting end and penetrate through the second pivoting end along a second direction perpendicular to the first direction.

In an embodiment, the handle is provided with a guiding hole extending along the first direction and penetrating through the first pivoting end along the second direction. The positioning member is movably limited in the guiding hole along the first direction.

In an embodiment, the positioning member has a second positioning portion extending along the first direction, and a body portion extending along the second direction. The second positioning portion is detachably engaged with one of the plurality of first positioning portions. The body portion is movably inserted through the guiding hole along the first direction. The positioning device further includes a control member connected to the body portion to synchronously control the positioning member.

In an embodiment, the control member has a limiting portion extending along the second direction. The limiting portion is disposed in the guiding hole and abuts against the body portion of the positioning member.

In an embodiment, the positioning device further includes a housing mounted on the first pivoting end, and the positioning member and the at least one biasing member are disposed in the housing.

In an embodiment, the positioning member further has two stopping portions respectively formed on two opposite sides of the body portion, and a first separating portion formed between the two stopping portions. The number of the at least one biasing member is two. The housing has an inner wall surface and a second separating portion protruding from the inner wall surface. The two biasing members respectively elastically abut against the two stopping portions and the inner wall surface and are located on opposite sides of the first separating portion and the second separating portion.

In an embodiment, the positioning device further includes a cover mounted on the housing.

In an embodiment, the two biasing members are respectively torsion springs and are arranged in parallel along the first direction.

In another embodiment, the number of the at least one biasing member is one. The housing has a slot extending along the first direction, and the biasing members elastically abuts against the body portion and a bottom surface of the slot.

In another embodiment, the positioning member further has two stopping portions respectively formed on two opposite sides of the body portion. The housing further has a shoulder portion formed in the slot, and the two stopping portions selectively abut against the shoulder portion as the positioning member moves relative to the guiding hole.

In another embodiment, the positioning device further includes a cover mounted on the housing.

In an embodiment, the handle is provided with a first pivoting hole penetrating through the first pivoting end along the second direction. The tool head is provided with a second pivoting hole penetrating through the second pivoting end along the second direction. A pivoting member is inserted through the first pivoting hole and the second pivoting hole.

The present invention will become clearer in light of the following detailed description of illustrative embodiments of this invention described in connection with the drawings.

### BRIEF DESCRIPTION OF DRAWINGS

FIG. 1 is a perspective view of an adjustable angle tool of a first embodiment according to the present invention.

FIG. 2 is a partial exploded perspective view of the adjustable angle tool of FIG. 1.

FIG. 3 is a partial cross sectional view of the adjustable angle tool of FIG. 1.

FIG. 4 is another partial cross sectional view of the adjustable angle tool of FIG. 1 and indicates that the positioning member is in a locked position.

FIG. 5 is a continued view of FIG. 4 and indicates that the positioning member is in an unlocked position.

FIG. 6 is a continued view of FIG. 5 and indicates that after the relative angle between the blade head and the handle changes, the positioning member returns to the locked position.

FIG. 7 is a perspective view of an adjustable angle tool of a second embodiment according to the present invention.

FIG. 8 is a partial exploded perspective view of the adjustable angle tool of FIG. 7.

FIG. 9 is a partial cross sectional view of the adjustable angle tool of FIG. 7.

FIG. 10 is another partial cross sectional view of the adjustable angle tool of FIG. 7 and indicates that the positioning member is in a locked position.

FIG. 11 is a perspective view of an adjustable angle tool of a third embodiment according to the present invention.

FIG. 12 is a perspective view of an adjustable angle tool of a fourth embodiment according to the present invention.

FIG. 13 is a perspective view of an adjustable angle tool of a fifth embodiment according to the present invention.

### DETAILED DESCRIPTION OF THE INVENTION

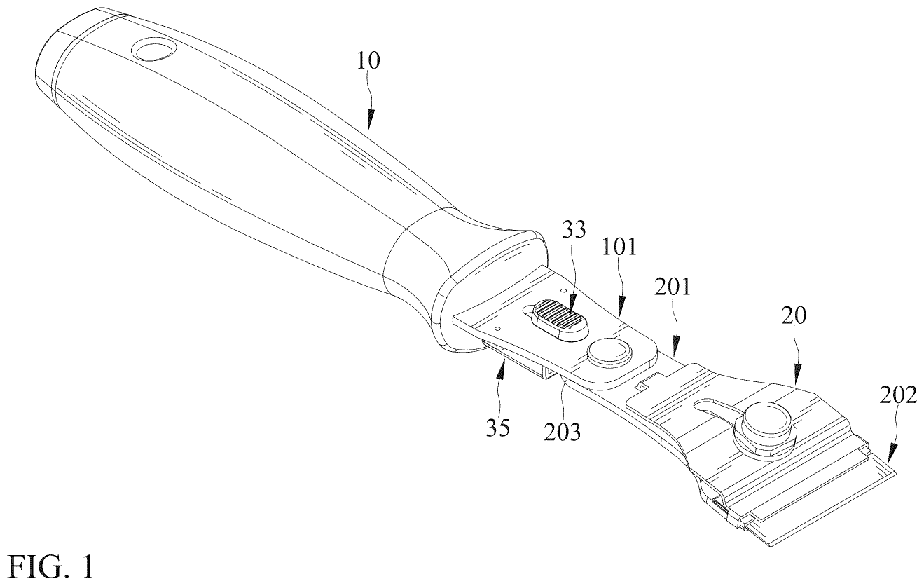

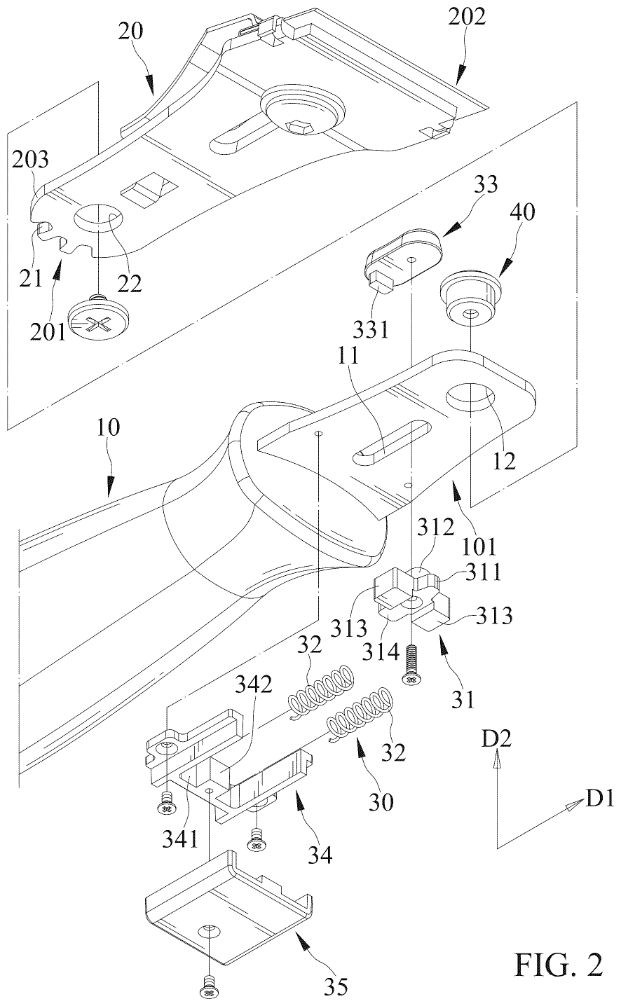

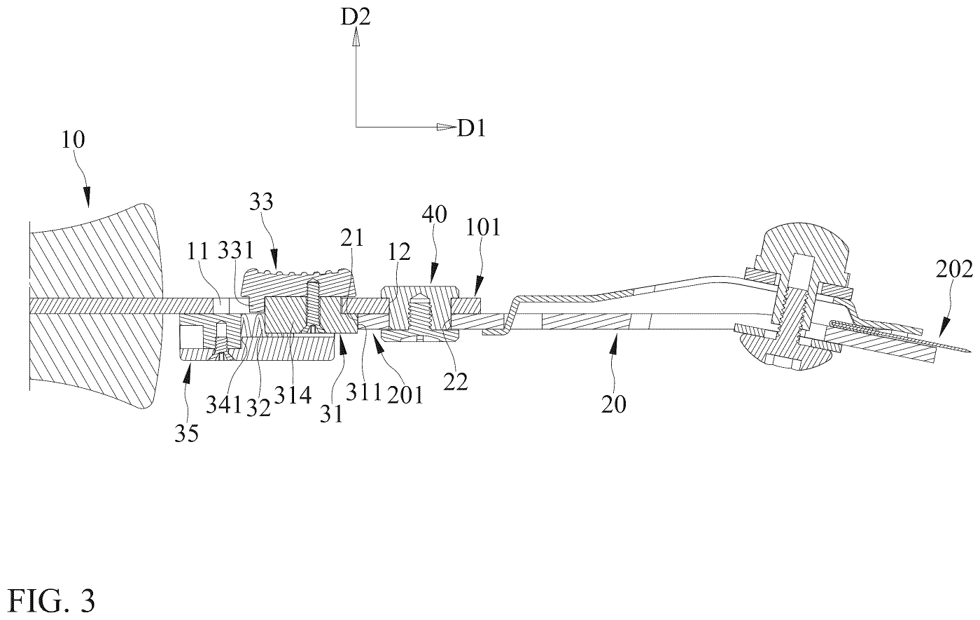

FIGS. 1-6 show an adjustable angle tool of a first embodiment according to the present invention. The adjustable angle tool comprises a handle 10, a tool head 20 pivotally connected to the handle 10, and a positioning device 30. The handle 10 extends along a first direction D1 for a user to grip. The tool head 20 is provided with a plurality of first positioning portions 21. The positioning device 30 includes a positioning member 31 and at least one biasing member 32. The positioning member 31 is configured to be biased by the at least one biasing member 32 along the first direction D1 and detachably engaged with one of the plurality of first positioning portions 21 to adjust a relative angle between the tool head 20 and the handle 10. Furthermore, the positioning member 31 is normally biased by the at least one biasing member 32 to engage one of the plurality of first positioning portions 21, thereby placing the positioning member 31 in a locked position, preventing the tool head 20 from pivoting relative to the handle 10. The user can apply an external force to counteract the biasing force exerted by the at least one biasing member 32 on the positioning member 31, causing the positioning member 31 to disengage from the first positioning portion 21, thus placing the positioning member 31 in an unlocked position. In this state, the tool head 20 is pivotable relative to the handle 10 until the desired relative angle between the tool head 20 and the handle 10 is achieved. The user can then stop applying the external force, allowing the positioning member 31 to be biased by at least one biasing member 32 to engage another first positioning portion 21, thereby returning to the locked position.

To enable the positioning member 31 to be detachably engaged with any of the first positioning portions 21, the handle 10 has a first pivoting end 101. The head 20 has a second pivoting end 201 pivotally connected to the first pivot end 101, and an operating edge end 202 opposite to the second pivot end 201. The plurality of first positioning portions 21 are arranged at equal angles on an arcuate outer edge wall 203 of the second pivoting end 201 and penetrate through the second pivoting end 201 along a second direction D2 perpendicular to the first direction D1. Further, the operating edge end 202 of this embodiment may have a scraper blade.

To enable the positioning member 31 to be biased along the first direction D1 by the at least one biasing member 32, the handle 10 is provided with a guiding hole 11 extending along the first direction D1 and penetrating through the first pivoting end 101 along the second direction D2. The positioning member 31 is movably limited in the guiding hole 11 along the first direction D1.

To facilitate the user in applying the external force to counteract the biasing force exerted by the at least one biasing member 32 on the positioning member 31, the positioning member 31 has a second positioning portion 311 extending along the first direction D1, and a body portion 312 extending along the second direction D2. The second positioning portion 311 is detachably engaged with one of the plurality of first positioning portions 21. The body portion 312 is movably inserted through the guiding hole 11 along the first direction D1. The positioning device 30 further includes a control member 33 connected to the body portion 312 to synchronously control the positioning member 31. Therefore, the user can apply the external force to the control member 33 to counteract the biasing force exerted by the at least one biasing member 32 on the positioning member 31, allowing the positioning member 31 to move relative to the guiding hole 11 along the first direction D1 and switch between the locked and unlocked positions.

Further, to enable the control member 33 to stably interlock with and control the positioning member 31, the control member 33 has a limiting portion 331 extending along the second direction D2, and the limiting portion 331 is disposed in the guiding hole 11 and abuts against the body portion 312 of the positioning member 31.

To enable the at least one biasing member 32 to stably bias the positioning member 31, the positioning device 30 further includes a housing 34 mounted on the first pivoting end 101, and the positioning member 31 and the at least one biasing member 32 are disposed in the housing 34. The positioning member 31 further has two stopping portions 313 respectively formed on two opposite sides of the body portion 312, and a first separating portion 314 formed between the two stopping portions 313. In this embodiment, the number of the at least one biasing member 32 is two. The housing 34 has an inner wall surface 341 and a second separating portion 342 protruding from the inner wall surface 341. The two biasing members 32 respectively elastically abut against the two stopping portions 313 and the inner wall surface 341 and are located on opposite sides of the first separating portion 314 and the second separating portion 342. The positioning device 30 further includes a cover 35 mounted on the housing 34, especially through screw assembly to the housing 34. In this embodiment, the two biasing members 32 are respectively torsion springs and are arranged in parallel along the first direction D1.

To pivotally connect the tool head 20 to the handle 10, the handle 10 is provided with a first pivoting hole 12 penetrating through the first pivoting end 101 along the second direction D2, and the tool head 20 is provided with a second pivoting hole 22 penetrating through the second pivoting end 201 along the second direction D2. A pivoting member 40 is inserted through the first pivoting hole 12 and the second pivoting hole 22.

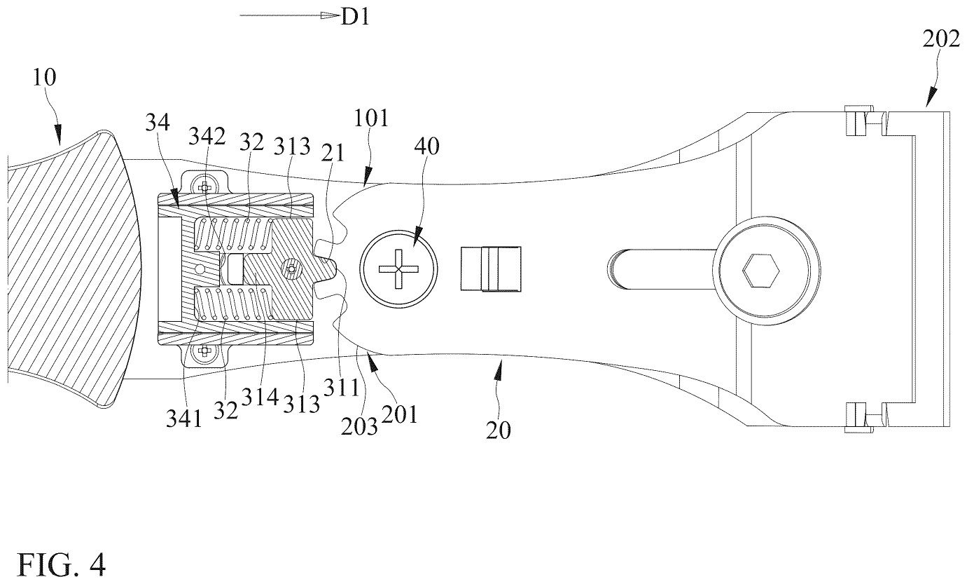

As shown in FIG. 4, the positioning member 31 is normally biased by the two biasing members 32 to engage with one of the plurality of first positioning portions 21 and is in the locked position. In this state, the tool head 20 cannot pivot relative to the handle 10, and the tool head 20 and handle 10 are aligned approximately in a straight line along the first direction D1.

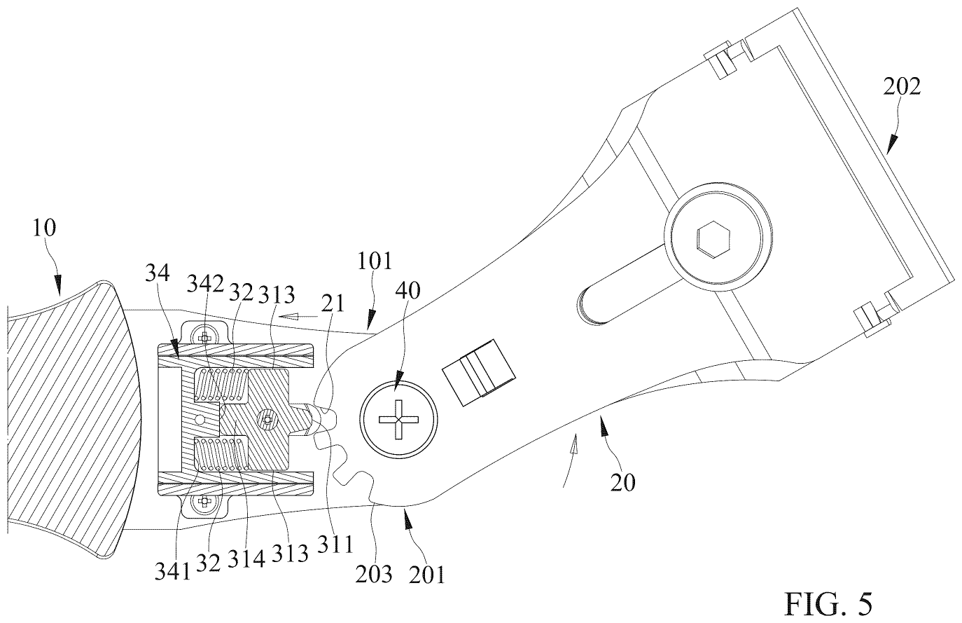

As shown in FIG. 5, the user can apply the external force to counteract the biasing force exerted by the two biasing members 32 on the positioning member 31. The two biasing members 32 are compressed between the two stopping portions 313 and the inner wall surface 341, and are located on both sides of the first separating portion 314 and the second separating portion 342, respectively. This causes the second positioning portion 311 of the positioning member 31 to disengage from the first positioning portion 21 as shown in FIG. 4 and be in the unlocked position, allowing the tool head 20 to pivot relative to the handle 10 until the desired relative angle between the tool head 20 and the handle 10 is achieved, aligning the positioning member 31 with another first positioning portion 21.

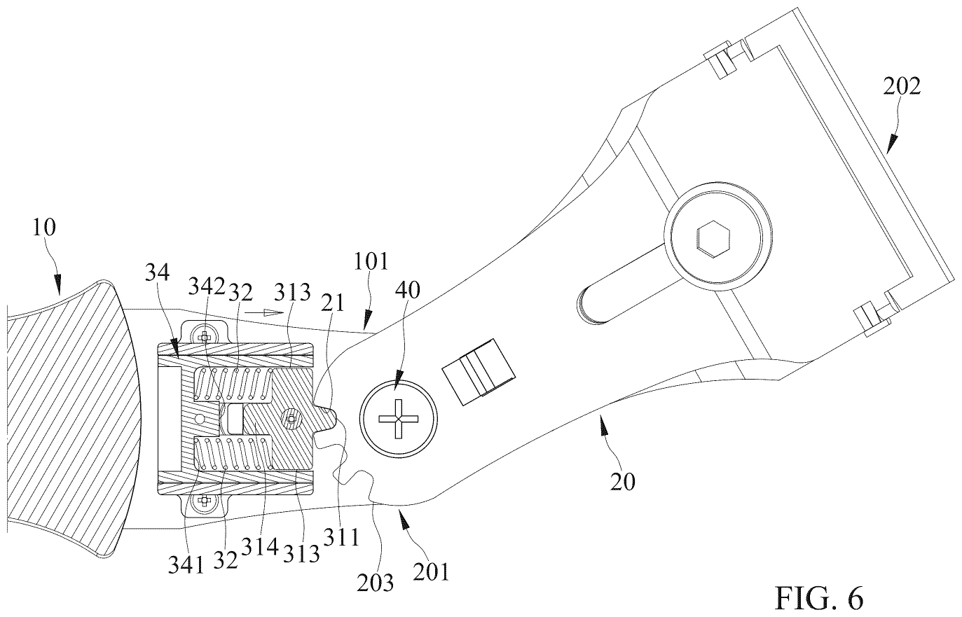

As shown in FIG. 6, when the user stops applying the external force, the positioning member 31 is biased by the elastic restoring force of the two biasing members 32, causing the second positioning portion 311 to engage with the first positioning portion 21 aligned in FIG. 5. This returns the positioning member 31 from the unlocked position to the locked position, preventing the tool head 20 from pivoting relative to the handle 10, thereby fixing the desired relative angle between the tool head 20 and the handle 10.

In summary, in the embodiment of the present invention, the positioning member 31 is configured to be biased by the two biasing member 32 along the first direction D1 and detachably engaged with one of the plurality of first positioning portions 21, to selectively adjust the relative angle between the tool head 20 and the handle 10.

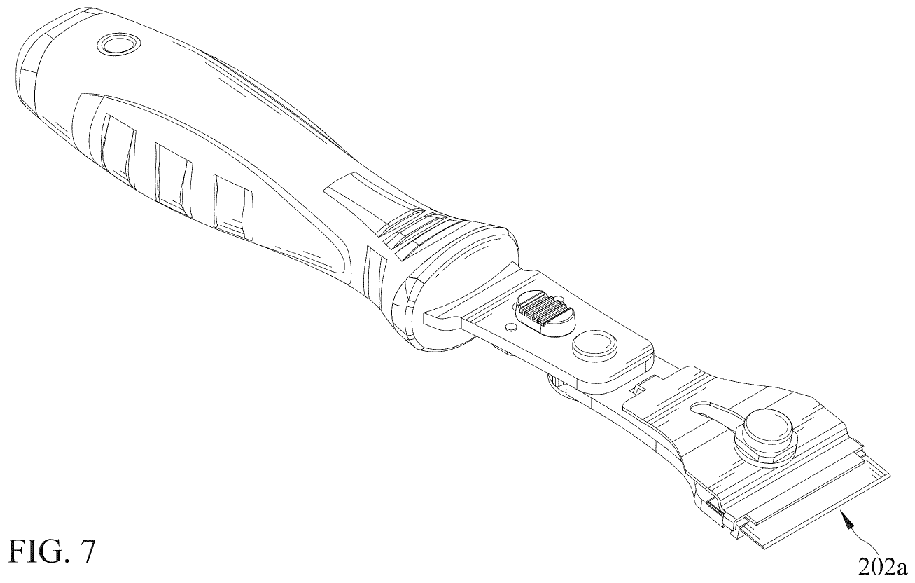

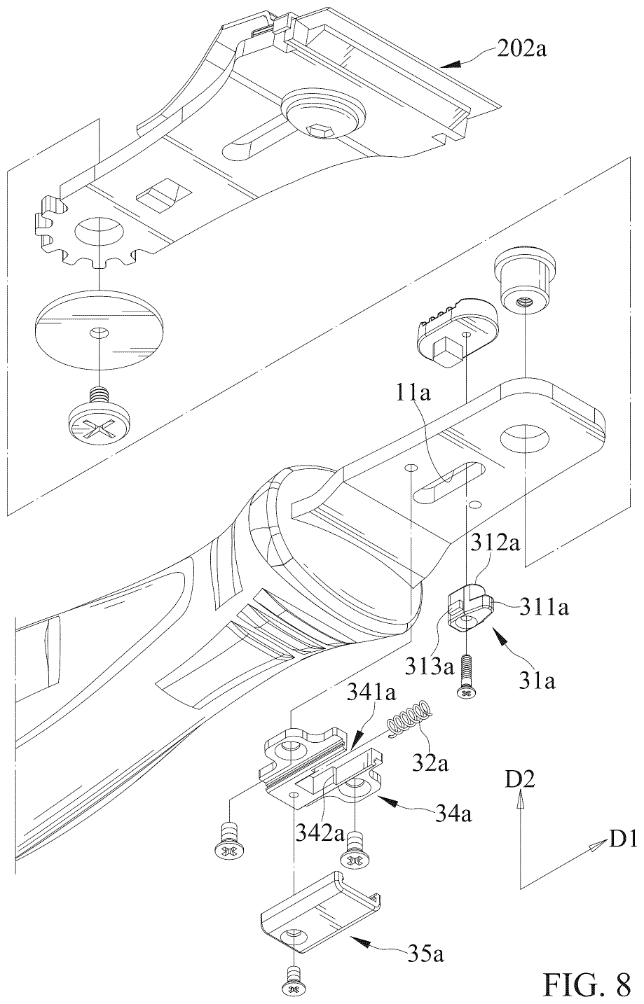

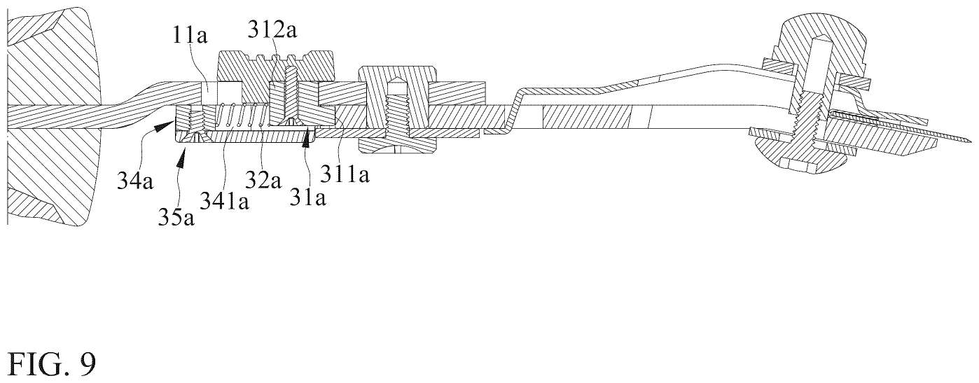

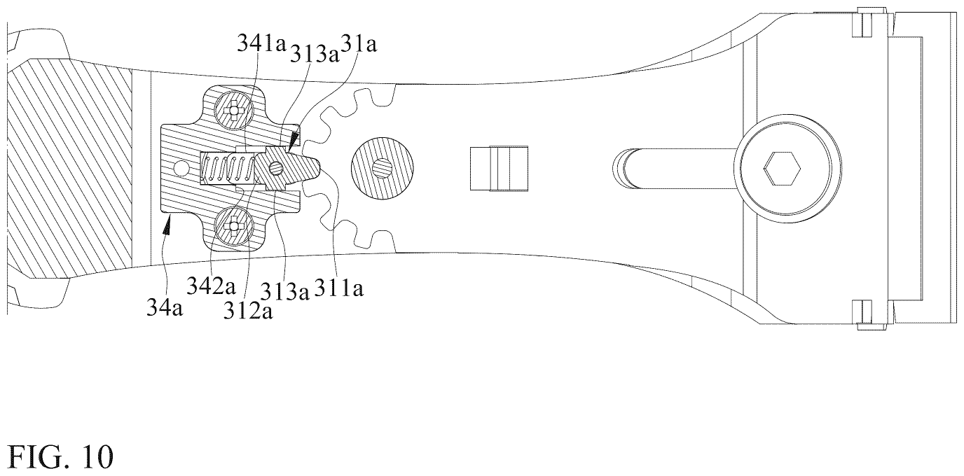

FIGS. 7-10 show an adjustable angle tool of a second embodiment according to the present invention. The second embodiment is substantially the same as the first embodiment, the operating edge end 202a of this embodiment also may have a scraper blade and the main difference therebetween is that the number of the at least one biasing member 32a is one. The housing 34a has a slot 341a extending along the first direction D1, and the biasing members 32a elastically abuts against the body portion 312a and a bottom surface of the slot 341a. The positioning member 31a further has two stopping portions 313a respectively formed on two opposite sides of the body portion 312a, and the housing 34a further has a shoulder portion 342a formed in the slot 341a. The two stopping portions 313a selectively abut against the shoulder portion 342a as the positioning member 31a moves relative to the guiding hole 11a. Further, the two stopping portions 313a abut against the shoulder portion 342a when the positioning member 31a is in the unlocked position. Additionally, the positioning device 30a further includes a cover 35a mounted on the housing 34a.

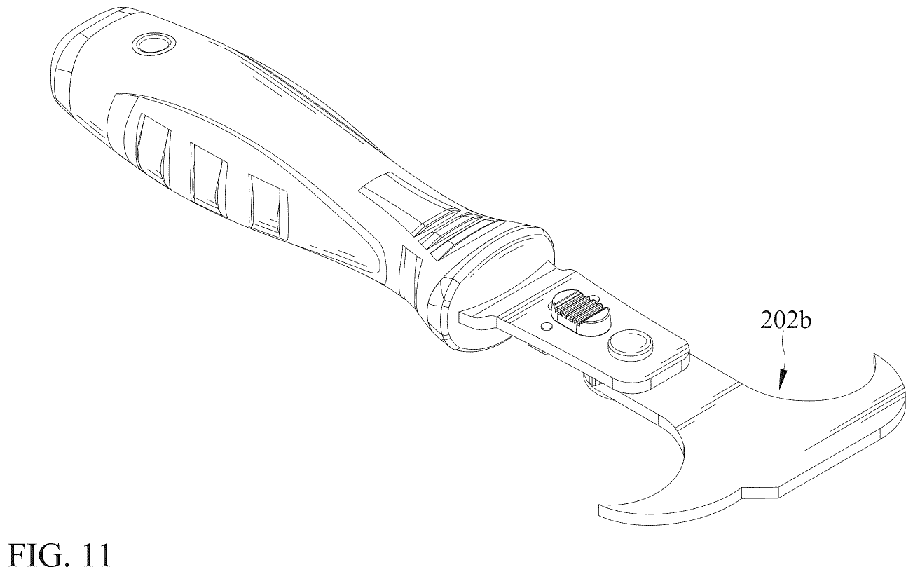

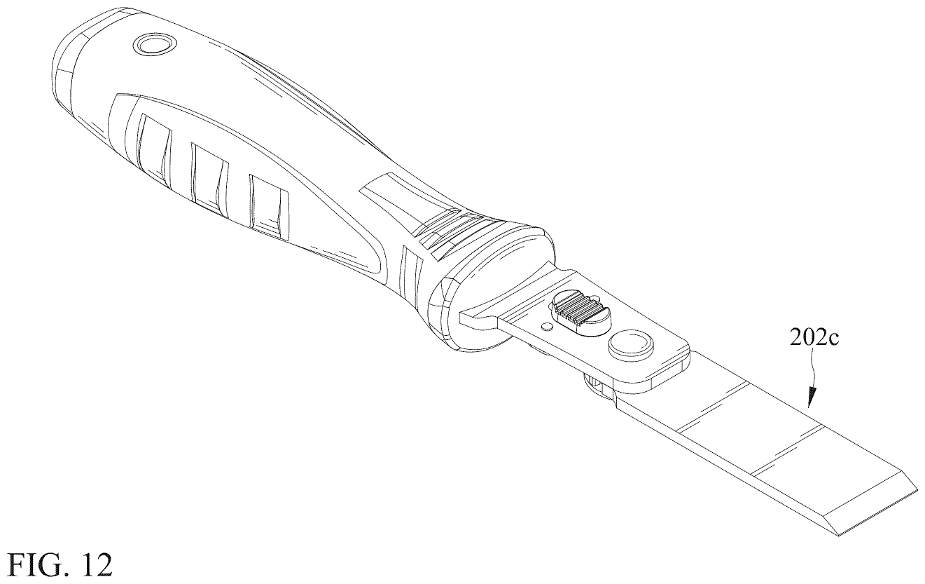

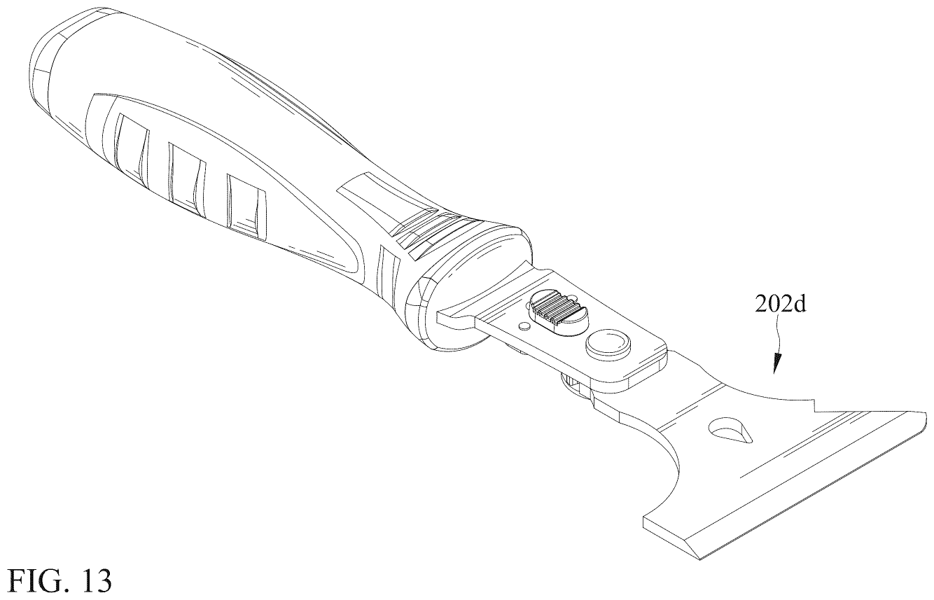

FIGS. 11-13 respectively show the adjustable angle tools of the third, fourth, and fifth embodiments of the present invention. These embodiments are substantially the same as the second embodiment, with the main difference being the different types of the operating ends 202b, 202c, and 202d, each of which features a distinct type of scraper.

Although specific embodiments have been illustrated and described, numerous modifications and variations are still possible without departing from the scope of the invention. The scope of the invention is limited by the accompanying claims.

1. An adjustable angle tool comprising:
a handle extending along a first direction;
a tool head pivotally connected to the handle and provided with a plurality of first positioning portions; and
a positioning device including a positioning member and at least one biasing member, wherein the positioning member is configured to be biased by the at least one biasing member along the first direction and detachably engaged with one of the plurality of first positioning portions to adjust a relative angle between the tool head and the handle.

2. The adjustable angle tool as claimed in claim 1, wherein the handle has a first pivoting end, wherein the tool head has a second pivoting end pivotally connected to the first pivoting end, and an operating end opposite to the second pivoting end, and wherein the plurality of first positioning portions are arranged at equal angles on an arcuate outer edge wall of the second pivoting end and penetrate through the second pivoting end along a second direction perpendicular to the first direction.

3. The adjustable angle tool as claimed in claim 2, wherein the handle is provided with a guiding hole extending along the first direction and penetrating through the first pivoting end along the second direction, and wherein the positioning member is movably limited in the guiding hole along the first direction.

4. The adjustable angle tool as claimed in claim 3, wherein the positioning member has a second positioning portion extending along the first direction, and a body portion extending along the second direction, wherein the second positioning portion is detachably engaged with one of the plurality of first positioning portions, wherein the body portion is movably inserted through the guiding hole along the first direction, and wherein the positioning device further includes a control member connected to the body portion to synchronously control the positioning member.

5. The adjustable angle tool as claimed in claim 4, wherein the control member has a limiting portion extending along the second direction, and wherein the limiting portion is disposed in the guiding hole and abuts against the body portion of the positioning member.

6. The adjustable angle tool as claimed in claim 4, wherein the positioning device further includes a housing mounted on the first pivoting end, and wherein the positioning member and the at least one biasing member are disposed in the housing.

7. The adjustable angle tool as claimed in claim 6, wherein the positioning member further has two stopping portions respectively formed on two opposite sides of the body portion, and a first separating portion formed between the two stopping portions, wherein the number of the at least one biasing member is two, wherein the housing has an inner wall surface and a second separating portion protruding from the inner wall surface, and wherein the two biasing members respectively elastically abut against the two stopping portions and the inner wall surface and are located on opposite sides of the first separating portion and the second separating portion.

8. The adjustable angle tool as claimed in claim 7, wherein the positioning device further includes a cover mounted on the housing.

9. The adjustable angle tool as claimed in claim 7, wherein the two biasing members are respectively torsion springs and are arranged in parallel along the first direction.

10. The adjustable angle tool as claimed in claim 6, wherein the number of the at least one biasing member is one, wherein the housing has a slot extending along the first direction, and wherein the biasing members elastically abuts against the body portion and a bottom surface of the slot.

11. The adjustable angle tool as claimed in claim 10, wherein the positioning member further has two stopping portions respectively formed on two opposite sides of the body portion, wherein the housing further has a shoulder portion formed in the slot, and wherein the two stopping portions selectively abut against the shoulder portion as the positioning member moves relative to the guiding hole.

12. The adjustable angle tool as claimed in claim 10, wherein the positioning device further includes a cover mounted on the housing.

13. The adjustable angle tool as claimed in claim 2, wherein the handle is provided with a first pivoting hole penetrating through the first pivoting end along the second direction, wherein the tool head is provided with a second pivoting hole penetrating through the second pivoting end along the second direction, and wherein a pivoting member is inserted through the first pivoting hole and the second pivoting hole.
